(19) United States
(12) Patent Application Publication
(10) Pub. No.: US 2026/0324602 A1
(43) Pub. Date: Oct. 22, 2026

(54) System and Method for Measurement of the Worker Populations of Honey Bee Colonies Using Deep Learning

(71) Applicants: Jun Chen, Gilbert, AZ (US); Junmin Zhong, Gilbert, AZ (US); Jon Harrison, Tempe, AZ (US)

(72) Inventors: Jun Chen, Gilbert, AZ (US); Junmin Zhong, Gilbert, AZ (US); Jon Harrison, Tempe, AZ (US)

(21) Appl. No.: 19/651,433

(22) Filed: Apr. 17, 2026

Related U.S. Application Data
(60) Provisional application No. 63/791,239, filed on Apr. 18, 2025.

(51) Int. Cl. A01K 29/00; G06T 7/11; G06V 20/70

(52) U.S. Cl. CPC A01K 29/005; G06T 7/11; G06V 20/70; G06T 2207/20081; G06T 2207/20084

(57) ABSTRACT

Some embodiments of the present disclosure may provide technology for detecting bee population health. In some embodiments, an image of a beehive may be received, the image may be partitioned into a plurality of sub-images, a trained model may be applied to the plurality of sub-images to generate a plurality of bee density maps corresponding to the plurality of sub-images, and a bee population estimate may be generated from the plurality of bee density maps. In some embodiments, the trained model may comprise a convolutional neural network. In some embodiments, a training image of bees may be obtained, the training image may be annotated by associating each bee with a pixel coordinate, and a training density map comprising normalized distributions associated with the bee pixel coordinates may be generated.

### CROSS-REFERENCE TO RELATED APPLICATIONS

This application claims the benefit of and priority to U.S. Application No. 63/791,239, filed on Apr. 18, 2025, the entirety of which is incorporated herein by reference.

### STATEMENT REGARDING FEDERALLY SPONSORED RESEARCH OR DEVELOPMENT

This invention was made with government support under 2022-67013-36285 awarded by the USDA/NIFA. The government has certain rights in the invention.

### BACKGROUND

Honey bees play a vital role in plant reproduction through pollination, supporting biodiversity and maintaining healthy food webs. Approximately 80% of all flowering crops rely on animal pollinators, with honey bees responsible for pollinating over 130 types of fruits and vegetables. Certain crops—such as almonds, kiwifruit, macadamia nuts, and blueberries—are especially dependent on honey bee pollination for successful yield. Because bees are highly sensitive to environmental changes, their health can serve as a reliable bioindicator of ecosystem conditions. Thus, monitoring and managing bee health not only supports agriculture but also offers insights into broader environmental quality and ecosystem stability. However, traditional colony assessments—such as frame-weighing, visual estimates, or manual image analysis—are time-consuming, disruptive to the hive, and prone to inaccuracies or observer bias.

### SUMMARY

Embodiments of the present disclosure may provide a computer-implemented method of detecting bee population health comprising receiving an image of a beehive; partitioning the image into a plurality of sub-images; applying a trained model to the plurality of sub-images to generate a plurality of bee density maps corresponding to the plurality of sub-images; and generating a bee population estimate from the plurality of bee density maps.

In some embodiments, the method may further comprise obtaining a training image of bees; annotating the training image by associating each bee with a pixel coordinate; and generating a training density map comprising normalized distributions associated with the bee pixel coordinates.

In some embodiments, the method may further comprise partitioning the training image into a plurality of training sub-images; and generating the training density map as one of a plurality of training density maps, each training density map corresponding to one of the plurality of training sub-images.

In some embodiments, the method may further comprise generating the trained model, comprising obtaining a pre-trained model; initializing dilated layers for the pre-trained model based on a statistical distribution; and training the pre-trained model using the training density maps as ground truths.

In some embodiments, the method may further comprise generating, based on the bee population estimate, an ecosystem health indicator of an ecosystem comprising the beehive.

Embodiments of the present disclosure may provide a system for detecting bee population health, comprising: a processor; a non-transitory computer-readable medium storing instructions executable by the processor to: receive an image of a beehive; partition the image into a plurality of sub-images; apply a trained model to the plurality of sub-images to generate a plurality of bee density maps corresponding to the plurality of sub-images; and generate a bee population estimate from the plurality of bee density maps.

Embodiments of the present disclosure may provide a non-transitory computer-readable medium storing instructions for detecting bee population health and executable by a processor to: receive an image of a beehive; partition the image into a plurality of sub-images; apply a trained model to the plurality of sub-images to generate a plurality of bee density maps corresponding to the plurality of sub-images; and generate a bee population estimate from the plurality of bee density maps.

In some embodiments, the stored instructions may be further executable by the processor to obtain a training image of bees; annotate the training image by associating each bee with a pixel coordinate; and generate a training density map comprising normalized distributions associated with the bee pixel coordinates.

In some embodiments, the stored instructions may be further executable by the processor to partition the training image into a plurality of training sub-images; and generate the training density map as one of a plurality of training density maps, each training density map corresponding to one of the plurality of training sub-images.

In some embodiments, the stored instructions may be further executable by the processor to generate the trained model by obtaining a pre-trained model; initializing dilated layers for the pre-trained model based on a statistical distribution; and training the pre-trained model using the training density maps as ground truths.

In some embodiments, the stored instructions may be further executable by the processor to generate, based on the bee population estimate, an ecosystem health indicator of an ecosystem comprising the beehive.

In some embodiments, the trained model may comprise a convolutional neural network.

In some embodiments, the trained model may comprise a convolutional neural network-based scale-adaptive regression network.

In some embodiments, the trained model may comprise a plurality of convolution layers and a plurality of dilated convolutions.

In some embodiments, the training density map may comprise a two-dimensional array comprising a total number of array elements corresponding to a total number of pixels in the training image and wherein each of the normalized distributions is centered at an array element corresponding to one of the bee pixel coordinates.

In some embodiments, the ecosystem health indicator may comprise a contaminant indicator, an air quality indicator, a water quality indicator, a plant health indicator, a habitat loss indicator, or a climate change indicator.

In some embodiments, the contaminant indicator may comprise a pathogen contamination indicator, a heavy metal contamination indicator, a chemical contamination indicator, or a radiation contamination indicator.

### BRIEF DESCRIPTION OF THE DRAWINGS

The features and advantages of the present disclosure, and the manner of attaining them, will become more apparent and the present disclosure will be better understood by reference to the description of the present disclosure taken in conjunction with the accompanying drawing.

FIG. 1 illustrates a flowchart for a computer-implemented method of detecting bee population health in accordance with some embodiments of the present disclosure.

FIG. 2 illustrates a flowchart for a computer-implemented method for training one or more deep learning models in accordance with some embodiments of the present disclosure.

FIG. 3 illustrates an example of a system for reconstructing bee image data in accordance with some embodiments of the present disclosure.

FIG. 4 illustrates an example of hardware that can be used to implement the system illustrated in FIG. 3 in accordance with some embodiments of the present disclosure.

FIG. 5A-FIG. 5K are images from an exemplary dataset, demonstrating multiple lighting conditions and angles, in accordance with some embodiments of the present disclosure.

Those of ordinary skill in the art will understand that the devices, systems, and methods specifically described herein and illustrated in the accompanying drawings are non-limiting exemplary embodiments and that the scope of the various embodiments of the present disclosure is defined solely by the claims. The features illustrated or described in connection with one exemplary embodiment may be combined with the features of other embodiments. Such modifications and variations are intended to be included within the scope of the present disclosure.

### DETAILED DESCRIPTION

In accordance with some embodiments of the disclosed subject matter, mechanism (which can include, for example, systems, devices, and methods) for counting a bee population are provided. Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

Existing bee-counting methods (e.g., weighing frames or manual grid overlays) are time-consuming and disruptive to hives. Embodiments of the present disclosure provide a system and method for accurately estimating honey bee colony populations through advanced computer vision crowd-counting techniques. The present disclosure's camera-based approach, combined with automated deep-learning inference, reduces colony disturbance and scales easily to large beekeeping operations—a substantial improvement over traditional methodologies. This automation may reduce human labor, reduce disturbances to the colony, and provides consistent, fine-scale estimates of colony demography. Consequently, researchers, beekeepers, and agricultural stakeholders can more efficiently monitor hive health, better predict colony performance, and implement timely management decisions to support sustainable beekeeping practices.

While crowd counting algorithms exist for human-centered applications, the present disclosure tailors methods (e.g., CSRNet) to handle the unique challenges presented by bees-such as high occlusion, varying scale, and complex clustering on frames. This domain-specific adaptation, including specialized density mapping parameters, represents a novel technological approach in the field of apiculture.

Embodiments of the present disclosure provide at least the following advantages over current methods and systems of counting a bee population:

a) Enhanced accuracy and consistency: Traditional methods rely on manual counting or observer-based estimates, both of which introduce human error and variability. By contrast, embodiments of the present disclosure employ automated, deep-learning algorithms that consistently produce precise estimates across multiple frames and varying conditions.
b) Minimally Invasive and Less Labor-Intensive: Existing techniques, such as weighing frames or painstaking visual inspection, can stress the hive and demand significant labor. Embodiments of the present disclosure reduce disruption by focusing on photographic capture, thereby minimizing risk to the bees and saving time for beekeepers or researchers.
c) Scalable to Large Operations: Manual counting methods become impractical at the scale of commercial beekeeping, where numerous hives need frequent population assessments. Embodiments of the present disclosure provide a high-throughput, automated method, system and/or device that allows for rapid processing of large image sets, enabling broader adoption across industrial and research contexts.

In some embodiments of the present disclosure, an advanced computer vision framework is used to rapidly and accurately estimate honey bee colony populations from digital images. By leveraging a specially curated dataset of high-resolution hive photographs, the system applies deep learning techniques to identify and count bees in varying densities, lighting conditions, and hive configurations. The commercial impact of this technology lies at least in its ability to provide consistent, hive population data with minimal disturbance to the bees. Potential applications include, but are not limited to, precision beekeeping, improved pollination management in agriculture, more efficient colony health monitoring for researchers and commercial operations alike, selective breeding efforts via consistent metrics for evaluating colony strength and resilience, ecosystem health monitoring, such as presence of contaminants (e.g., chemical pollutants, pathogens, radiation, etc.), air quality monitoring, water quality monitoring, crop or other plant health monitoring, etc.

Honey bee colonies are critically important for both agricultural pollination and natural ecosystems. Assessing the number of workers in a hive provides a key index of colony health, productivity, and survivability. Traditional colony population measurements—ranging from rapid frame occupancy checks to detailed weight-based and photographic methods—tend to be labor-intensive, disruptive to the bees, and subject to observer bias. These limitations pose significant challenges when accurate, large-scale, and minimally invasive data collection is required, such as in commercial beekeeping operations, pollination services, or intensive research studies.

Embodiments of the present disclosure provide computer vision and deep learning to automate and improve the precision of bee counting. Crowd counting algorithms, in particular, have shown promise for tackling difficult counting tasks across various domains. However, their application to honey bee populations faces unique hurdles, including the lack of a dedicated, high-resolution image dataset and the inherent variability of bee clustering and lighting conditions.

These challenges motivated the development of a new image dataset, ASUBEE, designed specifically for honey bee crowd counting. With nearly 400 high-resolution images (5184×3456) containing approximately 350,000 accurately labeled bees, ASUBEE provides a rich resource for training and testing deep learning models. Building on this dataset, an adapted CSRNet-based crowd counting framework overcomes issues of occlusion, lighting inconsistencies, and multi-scale density variations. By leveraging these computational tools, the technology significantly streamlines bee population estimation, reduces colony disturbance, and enhances research and management capabilities in apiculture.

Embodiments of the present disclosure provide at least the following advantages over current methods and systems of counting a bee population:

a) The Bee dataset (ASUBEE): The present disclosure introduces a uniquely curated, large-scale dataset of high-resolution hive photographs specifically designed for bee crowd counting. Previous image datasets either lacked sufficient resolution or were not intended for crowd counting tasks, making ASUBEE the first of its kind to support robust machine-learning models for this application.
b) The present disclosure provides a novel methodology for counting bees in crowded hive images using a specialized crowd-counting dataset (ASUBEE) and a deep-learning model (CSRNet). The present disclosure allows beekeepers, researchers, and other stakeholders to estimate colony populations rapidly and accurately without extensively disturbing the hive.

In some embodiments, a computer-implemented method of detecting bee population health may be performed using a suitably trained deep learning model or other machine learning model. As will be described, the deep learning model takes bee image data (e.g., images of hive boxes) as input data and generates an estimate of bee population as output data.

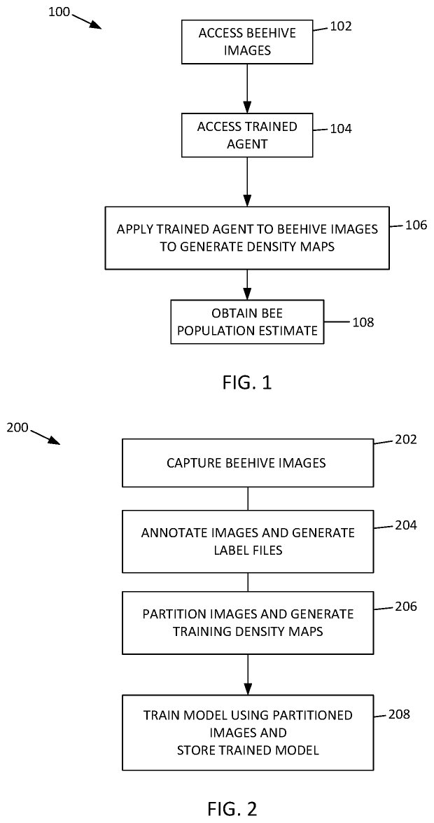

In some embodiments, the method includes accessing bee image data with a computer system, as indicated at step 102 (FIG. 1). In some embodiments, accessing the bee image data may include retrieving such data from a memory or other suitable data storage device or medium. In some embodiments, accessing the bee image data may include acquiring such data with an image capture device, such as a digital camera and transferring or otherwise communicating the data to the computer system. In some embodiments, as described above, the bee image data are generally images of beehive frames populated with bees.

In some embodiments, step 102 (FIG. 1) may include gently removing each frame so that the adult worker bees stay in place on both sides. In some embodiments, a high-resolution camera, such as a Canon® EOS Rebel T5, may be used to photograph each frame. In some embodiments, an image may be captured for each side of every frame. In some embodiments, an image may be captured for each side of every frame until all frames in the box have been photographed. In some embodiments, this procedure may be performed for multiple hives.

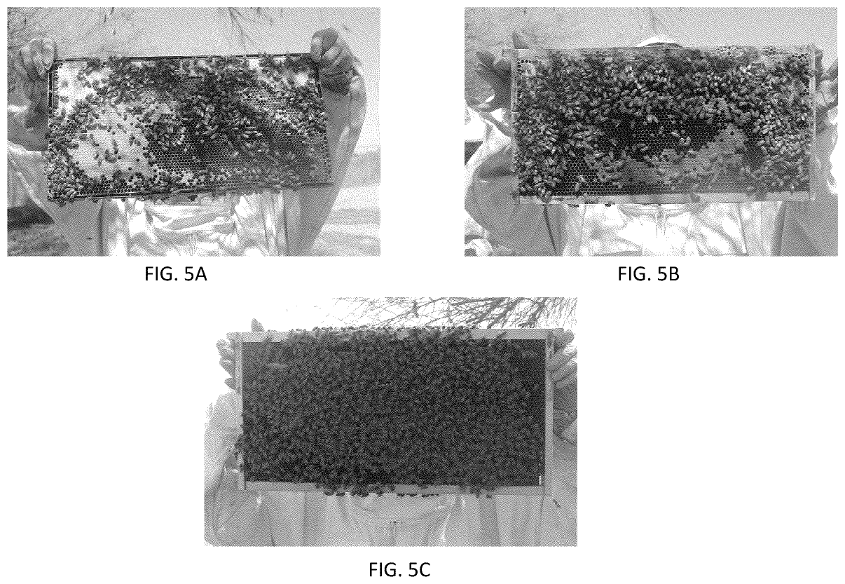

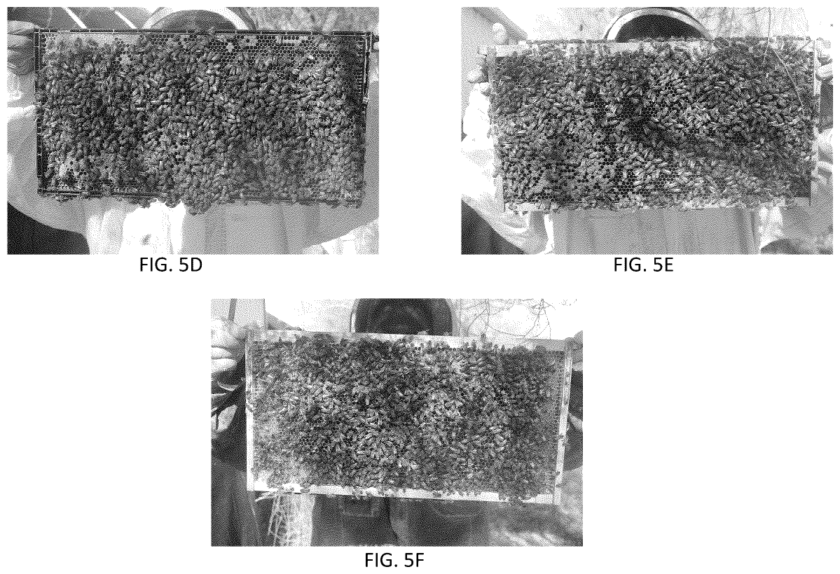

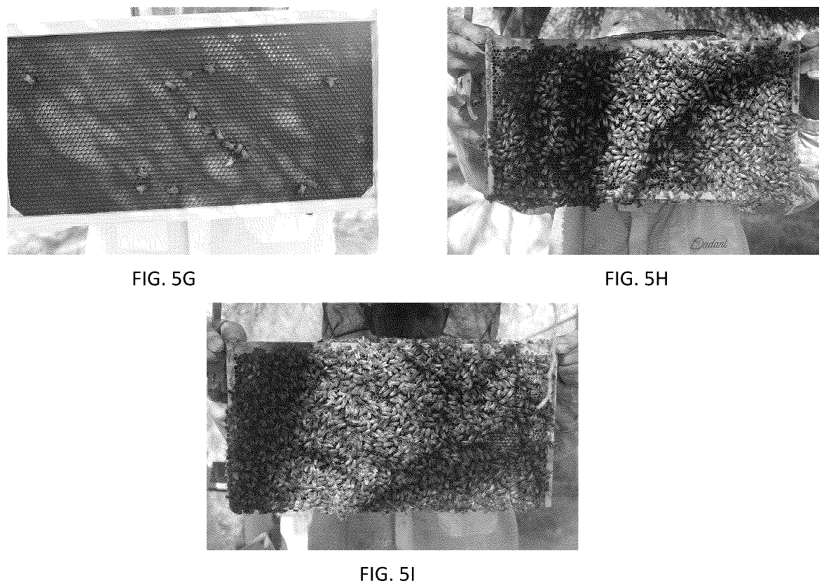

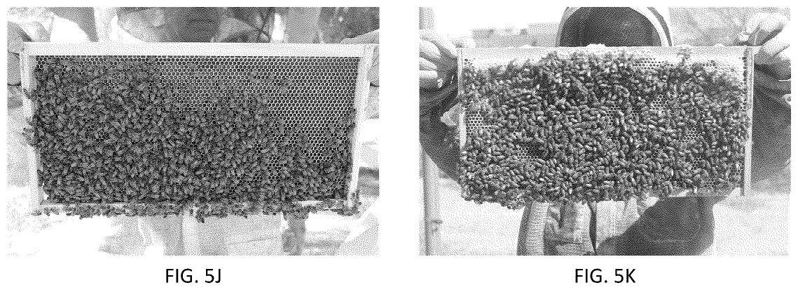

In an exemplary dataset, 40 hives were photographed across three days within a week (FIGS. 5A-5K). Each original image was saved in a high-resolution format (5184×3456 pixels). Multiple lighting conditions (FIGS. 5G-5K) and angles (FIGS. 5A-5F) were used, reflecting real-world variability (e.g., sunlight, shade, partial occlusions).

In some embodiments, a trained deep learning model (e.g., a neural network, tree-based transformer, reservoir computer, or other deep learning model) may be accessed with the computer system, as indicated at step 104 (FIG. 1). In some embodiments, the deep learning model is trained, or has been trained, on training data in order to estimate bee populations from image data, such as high-resolution images of beehives. In some embodiments, this estimation may be achieved, in part, by the deep learning model (or other machine learning model) being trained by comparing generated density maps to ground-truth density maps.

In some embodiments, the trained deep learning model can include a deep learning model with any suitable deep learning model architecture for generating bee density map data. As non-limiting examples, the trained deep learning model may include a convolution network, a U-net, a densely connected network, a generative AI model, a fully connected network, a recursive network, a residual net, a transformer, an attention module, generative adversarial model, inception module, reservoir computer, reinforcement learning models (e.g., actor-critic models, etc.), etc., and/or a combination thereof. An example framework is based on python (3.7+) with deep learning framework (PyTorch and OpenCV). The deep learning method used may be a Convolutional Neural Network-based Scale-Adaptive Regression Network (CSRNet) which consists of two main parts:
1) Front-end: Based on VGG-16 (using the convolution layers only, no fully connected layers).
2) Back-end: A series of dilated convolutions that preserve resolution while expanding the receptive field.

In some embodiments, accessing the trained deep learning model may include accessing network parameters (e.g., weights, biases, or both) that have been optimized or otherwise estimated by training the deep learning model on training data. In some embodiments, retrieving the deep learning model may also include retrieving, constructing, or otherwise accessing the particular deep learning model architecture to be implemented. For instance, data pertaining to the layers in a neural network architecture (e.g., number of layers, type of layers, ordering of layers, connections between layers, hyperparameters for layers) may be retrieved, selected, constructed, or otherwise accessed.

As an example deep learning model, a neural network generally includes an input layer, one or more hidden layers (or nodes), and an output layer. In some embodiments, the input layer connects to one or more hidden layers. In some embodiments, the number of hidden layers varies and may depend on the particular task for the neural network. In some embodiments, each hidden layer may have a different number of nodes and may be connected to the next layer differently. For example, each node of the input layer may be connected to each node of the first hidden layer. In some embodiments, the connection between each node of the input layer and each node of the first hidden layer may be assigned a weight parameter. In some embodiments, each node of the neural network may also be assigned a bias value. In some configurations, each node of the first hidden layer may not be connected to each node of the second hidden layer. That is, there may be some nodes of the first hidden layer that are not connected to all of the nodes of the second hidden layer. In some embodiments, the connections between the nodes of the first hidden layers and the second hidden layers are each assigned different weight parameters. In some embodiments, each node of the hidden layer is generally associated with an activation function. In some embodiments, the activation function defines how the hidden layer is to process the input received from the input layer or from a previous input or hidden layer. In some embodiments, these activation functions may vary and be based on the type of task associated with the neural network and also on the specific type of hidden layer implemented.

In some embodiments, each hidden layer may perform a different function. For example, some hidden layers can be convolutional hidden layers. In some embodiments, other hidden layers may perform statistical functions such as max pooling, which may reduce a group of inputs to the maximum value; an averaging layer; batch normalization; and other such functions. In some embodiments of the hidden layers each node is connected to each node of the next hidden layer, which may be referred to then as dense layers. Some neural networks including more than, for example, three hidden layers may be considered deep neural networks. In some embodiments, the last hidden layer in the neural network is connected to the output layer.

In some embodiments, the bee image data is then input to the trained deep learning model, generating output as bee density map data, as indicated at step 106 (FIG. 1). For example, the bee density map data may include a 2D density map whose integral approximates the total bee count. In some embodiments, step 106 (FIG. 1) may include: for each new high-resolution hive image (5184×3456) (obtained in step 102, FIG. 1), crop into 224×224 patches. Pass each 224×224 patch through the trained CSRNet model. Obtain predicted density maps for each patch. Sum the pixel values to get a predicted bee count for that patch

In some embodiments, the bee density map data generated by inputting the bee image data to the trained deep learning model(s) can then be displayed to a user, stored for later use or further processing, or both, as indicated at step 108 (FIG. 1). In some embodiments, step 108 (FIG. 1) may include estimating bee populations by aggregating counts from all patches in the original image. In some embodiments, step 108 (FIG. 1) may include summing partial counts to derive the estimated total bee population for the entire frame image. In some embodiments, step 108 (FIG. 1) may be performed using the trained model. In some embodiments, the trained model may be trained to generate a bee population estimate, such as by integrating the generated density maps. In some embodiments, step 108 (FIG. 1) may be performed by a subsequent process. In some embodiments, step 108 (FIG. 1) may include outputting the density maps to an application process that performs the integration to generate a bee population count estimate.

In some embodiments, step 108 (FIG. 1) may include using the bee population estimate to generate an ecosystem health indicator. Because bees are highly sensitive to environmental changes, their health can serve as a reliable bioindicator of ecosystem conditions. Monitoring bee populations can help detect the presence of pollutants such as pesticides, heavy metals, acid rain, airborne contaminants, etc. In some embodiments, the bee population estimate may be compared to previous or predicted population estimates. For instance, a negative indicator may be generated based on a drop in bee population (or the bee population being otherwise less than expected), while a positive indicator may be generated based on an increase in bee population (or the bee population being otherwise greater than expected). Some embodiments may include combining the bee population estimate with other measurements to determine bee health indicators. For instance, embodiments may include measuring pollen and/or honey stores and comparing the measurements to expected values for the measured bee population, where a lower than expected value may provide a negative health indicator. As another example, a honey bee population estimate may be used as a factor in measuring colony activity levels.

In various embodiments, the ecosystem health indicator may be indicative of any environmental aspect that may influence bee populations. For instance, the ecosystem health indicator may comprise a contaminant and/or pollutant indicator (e.g. indicators of pathogens, chemicals such as pesticides and/or heavy metals, radiation contamination, acid rain, airborne contaminants, etc.), an air quality indicator, a water quality indicator, a plant health indicator, a habitat loss indicator, a climate change indicator, etc., and/or combinations thereof.

Referring now to FIG. 2, in some embodiments, one or more deep learning models may be trained on training data to receive bee image data as input data in order to generate bee density map data as output data.

In some embodiments, the deep learning model(s) may implement any number of different deep learning model architectures. In some embodiments, the deep learning model(s) may implement a convolutional neural network, a residual neural network, or the like, and/or a combination thereof. In some embodiments, the deep learning model may implement other suitable machine learning or artificial intelligence algorithms, such as those based on supervised learning, unsupervised learning, deep learning, ensemble learning, dimensionality reduction, and so on, and/or a combination thereof.

In some embodiments, the method includes accessing training data with a computer system, as indicated at step 202 (FIG. 2). In some embodiments, step 202 (FIG. 2) may include obtaining an image of a beehive frame, such as from a data storage or an image capture device (e.g., still image or video camera). In some embodiments, step 202 (FIG. 2) may include:
1. manually opening each hive box carefully, ensuring minimal disruption to the bees;
2. gently removing each frame so that the adult worker bees stay in place on both sides;
3. using a high-resolution camera, such as a Canon® EQS Rebel T5, to photograph each frame such that at least one image is captured for each side of every frame.

In some embodiments, this process may continue until all frames in the box have been photographed. In some embodiments, step 202 (FIG. 2) may include performing this procedure for multiple hives. In the exemplary dataset, 40 hives were photographed across three days within a week. Each original image is saved in a high-resolution format (5184×3456 pixels). Multiple lighting conditions and angles are used, reflecting real-world variability (e.g., sunlight, shade, partial occlusions). temporally down-sampled training data generated from input bee image data. In some embodiments, the accessed training data may include bee image data received from an example database. In some embodiments, accessing the training data may include retrieving such data from a memory or other suitable data storage device or medium.

In some embodiments, the method may include assembling training data 204 (FIG. 2) from bee image data using a computer system. In some embodiments, this step may include assembling the bee image data into an appropriate data structure on which the deep learning model or other machine learning model may be trained. In some embodiments, the step may include importing each high-resolution image into an image-processing software such as ImageJ (NIH, Research Triangle Park, NC) or a similar tool. In some embodiments, the step may further include for every visible bee, placing a single point near the center of the bee's body. In some embodiments, the step may include generating a label file, such as by storing the (x, y) pixel coordinates of each annotated point in a label file corresponding to the image. As an example, in the ASUBEE dataset, 370 annotated images yield a total of 353,388 labeled bees. In some embodiments, each labeled position is treated as a delta function (i.e., a single point) for subsequent density-map generation.

In some embodiments, one or more deep learning models are trained on the training data, as indicated at step 204 (FIG. 2). In some embodiments, the deep learning model may be trained by optimizing parameters (e.g., neural network parameters (e.g., weights, biases, or both)) based on minimizing a loss function. In some embodiments, the loss function may be a Euclidean loss function. In some embodiments, the loss function may comprise a minimax loss function, mean square error loss function, Wasserstein loss function, Kullback-Leibler divergence loss function, etc., and or a combination thereof.

In some embodiments, method 200 (FIG. 2) may include step 206 (FIG. 2) of partitioning annotated images and corresponding label files to generate training density maps. In some embodiments, step 204 (FIG. 2) may include image preprocessing, such as subdividing each original high-resolution image into multiple 224×224-pixel patches. In some embodiments, in the dataset (e.g., ASUBEE) each image is cropped into 24 sub-images, resulting in 8,880 total sub-images. In some embodiments, step 206 (FIG. 2) may include adjusting the corresponding labels (points) within each cropped region to match the new coordinate system. In some embodiments, step 206 (FIG. 2) may then include generating training density maps of each image to help preserve spatial information and handle partial occlusions or varying scales. In some embodiments, step 206 (FIG. 2) may include, for each cropped image patch, reading the annotation file to identify the (x, y) pixel location of each bee. In some embodiments, the step may further include generating a zeroed array the same size as the image patch (224×224). In some embodiments, for each annotated point, a normalized Gaussian kernel is placed around that point. In some embodiments, the result is a 2D density map whose integral approximates the total bee count.

In some embodiments, training a deep learning model may include initializing the deep learning model, such as by computing, estimating, or otherwise selecting initial parameters (e.g., parameters such as weights, biases, or both). In some embodiments, step 208 (FIG. 2) may include initialization of a network using ImageNet-pretrained weights for the front-end and initialization of back-end dilated layers with a Gaussian distribution (standard deviation of 0.01).

In some embodiments, step 208 (FIG. 2) may include dividing data into training and validation data. In some embodiments, step 208 (FIG. 2) may include partitioning the cropped dataset into a training set (e.g., 7,104 images) and a testing set (e.g., 1,776 images). In some embodiments, the step may include maintaining a similar distribution of bee densities in both sets to ensure representative training and evaluation.

In some embodiments, step 208 (FIG. 2) may include training a model using a framework based on python (3.7+) with deep learning framework (PyTorch and OpenCV). An example deep learning model may include Convolutional Neural Network-based Scale-Adaptive Regression Network (CSRNet) which consists of two main parts:
1) Front-end: Based on VGG-16 (using the convolution layers only, no fully connected layers).
2) Back-end: A series of dilated convolutions that preserve resolution while expanding the receptive field.

In some embodiments, step 208 (FIG. 2) may include hyperparameter determinization or selection. In some embodiments, step 208 (FIG. 2) may include using a Stochastic Gradient Descent (SGD) optimizer with fixed learning rate 10\hat{ }(−7), momentum 0.95, and weight decay [symbol] 5*10 [symbol] \hat{ }(−4). In some embodiments, a batch size of 4 and maximum epochs count of 200 may be employed.

In some embodiments, step 208 (FIG. 2) may include loading each 224×224 image patch and its corresponding density map. In some embodiments, forward propagation through CSRNet may be performed. In some embodiments, the step may include computing the Euclidean loss using the ground-truth density map. In some embodiments, backpropagation may be performed to update weights via SGD. In some embodiments, this process may be repeated for a number of epochs, such as between 50-300 epochs (e.g., 50, 100, 200, 300 epochs, etc.), or until convergence. In some embodiments, step 208 (FIG. 2) may further include storing the resulting trained deep learning model (CSRNet) trained to handle varying bee densities, lighting conditions, and occlusions with multi-scale feature extraction.

In some embodiments, during training, a deep learning model receives the inputs for a training example and generates an output using the bias for each node, and the connections between each node and the corresponding weights. In some embodiments, training data can be input to the initialized deep learning model, generating output as temporally reduced spatiotemporal bee image data. In some embodiments, the deep learning model then compares the generated output with the actual output of the training example in order to evaluate the quality of the bee density map data. In some embodiments, the bee density map data can be passed to a loss function to compute an error. In some embodiments, the current deep learning model can then be updated based on the calculated error (e.g., using backpropagation methods based on the calculated error). In some embodiments, the current deep learning model can be updated by updating the network parameters (e.g., weights, biases, or both) in order to minimize the loss according to a loss function, such as a Euclidean loss function, mean-squared error, etc., or a combined loss function in a generative adversarial network (GAN), such as the combination of a generator loss and a discriminator loss, etc. In some embodiments, the training continues until a training condition is met. In some embodiments, the training condition may correspond to, for example, a predetermined number of training examples being used, a minimum accuracy threshold being reached during training and validation, a predetermined number of validation iterations being completed, and the like. In some embodiments, when the training condition has been met (e.g., by determining whether an error threshold or other stopping criterion has been satisfied), the current deep learning model and its associated parameters represent the trained deep learning model. In some embodiments, different types of training processes can be used to adjust the bias values and the weights of the node connections based on the training examples. In some embodiments, the training processes may include, for example, gradient descent, Newton's method, conjugate gradient, quasi-Newton, Levenberg-Marquardt, among others.

In some embodiments, the deep learning model can be constructed or otherwise trained based on training data using one or more different learning techniques, such as supervised learning, unsupervised learning, reinforcement learning, ensemble learning, active learning, transfer learning, or other suitable learning techniques for deep learning models. As an example, supervised learning involves presenting a computer system with example inputs and their actual outputs (e.g., categorizations). In some embodiments, the deep learning model is configured to learn a general rule or model that maps the inputs to the outputs based on the provided example input-output pairs.

In some embodiments, the one or more trained deep learning models are then stored for later use. In some embodiments, storing the deep learning model(s) may include storing parameters (e.g., weights, biases, or both), which have been computed or otherwise estimated by training the deep learning model(s) on the training data. In some embodiments, storing the trained deep learning model(s) may also include storing the particular deep learning model architecture to be implemented. In some embodiments, data pertaining to layers in a neural network architecture (e.g., number of layers, type of layers, ordering of layers, connections between layers, hyperparameters for layers) may be stored.

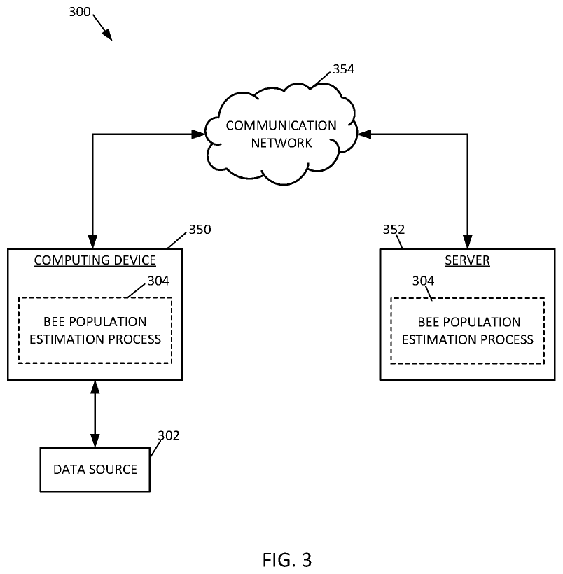

A system 300 (FIG. 3) for reconstructing bee image data may include a computing device (FIG. 3) and a server (FIG. 3). A computing device 350 (FIG. 3) can receive one or more types of data (e.g., bee image data) from data source 302. In some embodiments, computing device 350 (FIG. 3) can execute at least a portion of a bee population estimation process 304 (FIG. 3) to estimate bee population of a beehive from data received from the data source 302 (FIG. 3).

Additionally or alternatively, in some embodiments, the computing device 350 (FIG. 3) can communicate information about data received from the data source 302 (FIG. 3) to a server 352 (FIG. 3) over a communication network 354 (FIG. 3), which can execute at least a portion of the bee population estimation process 304 (FIG. 3). In such embodiments, the server 352 (FIG. 3) can return information to the computing device 350 (FIG. 3) (and/or any other suitable computing device) indicative of an output of the bee population estimation process 304 (FIG. 3).

In some embodiments, computing device 350 (FIG. 3) and/or server 352 (FIG. 3) can be any suitable computing device or combination of devices, such as a desktop computer, a laptop computer, a smartphone, a tablet computer, a wearable computer, a server computer, a virtual machine being executed by a physical computing device, and so on. In some embodiments, the computing device 350 (FIG. 3) and/or server 352 (FIG. 3) may also reconstruct images from the data.

In some embodiments, data source 302 (FIG. 3) can be any suitable source of data, another computing device (e.g., a server storing image data, label files, labeled images reconstructed from measurement data, processed image data), and so on. In some embodiments, data source 302 (FIG. 3) can be local to computing device 350 (FIG. 3). For example, data source 302 (FIG. 3) can be incorporated with computing device 350 (FIG. 3) (e.g., computing device 350 can be configured as part of a device for measuring, recording, estimating, acquiring, or otherwise collecting or storing data). In some embodiments, data source 302 (FIG. 3) can be connected to computing device 350 (FIG. 3) by a cable, a direct wireless link, and so on. Additionally or alternatively, in some embodiments, data source 302 (FIG. 3) can be located locally and/or remotely from computing device 350 (FIG. 3) and can communicate data to computing device 350 (FIG. 3) (and/or server 352, FIG. 3) via a communication network (e.g., communication network 354, FIG. 3).

In some embodiments, communication network 354 (FIG. 3) can be any suitable communication network or combination of communication networks. In some embodiments, communication network 354 (FIG. 3) can include a Wi-Fi network (which can include one or more wireless routers, one or more switches, etc.), a peer-to-peer network (e.g., a Bluetooth network), a cellular network (e.g., a 3G network, a 4G network, etc., complying with any suitable standard, such as CDMA, GSM, LTE, LTE Advanced, WiMAX, etc.), other types of wireless network, a wired network, and so on. In some embodiments, communication network 354 (FIG. 3) can be a local area network, a wide area network, a public network (e.g., the Internet), a private or semi-private network (e.g., a corporate or university intranet), any other suitable type of network, or any suitable combination of networks. Communications links shown in FIG. 3 can each be any suitable communications link or combination of communications links, such as wired links, fiber optic links, Wi-Fi links, Bluetooth links, cellular links, and so on.

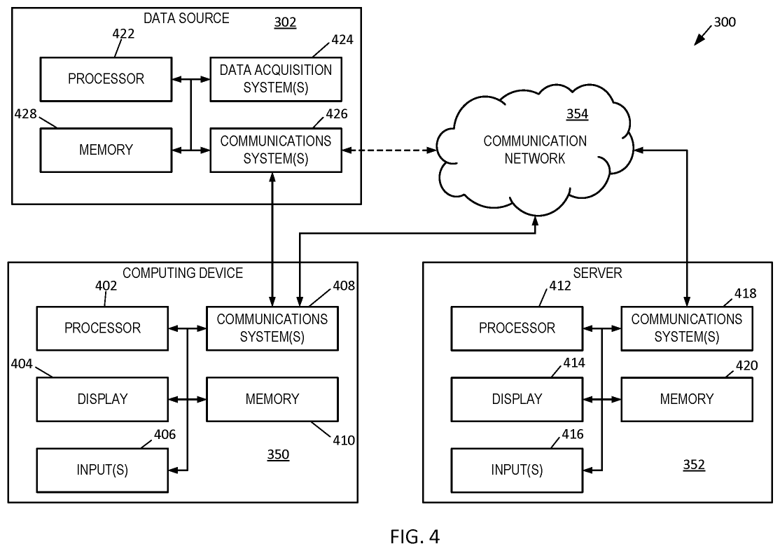

As shown in FIG. 4, in some embodiments, computing device 350 (FIG. 3) can include a processor 402 (FIG. 4), a display 404 (FIG. 4), one or more inputs 406 (FIG. 4), one or more communication systems 408 (FIG. 4), and/or memory 410 (FIG. 4). In some embodiments, processor 402 (FIG. 4) can be any suitable hardware processor or combination of processors, such as a central processing unit (CPU), a graphics processing unit (GPU), and so on. In some embodiments, display 404 (FIG. 4) can include any suitable display devices, such as a liquid crystal display (LCD) screen, a light-emitting diode (LED) display, an organic LED (OLED) display, an electrophoretic display (e.g., an “e-ink” display), a computer monitor, a touchscreen, a television, and so on. In some embodiments, inputs 406 (FIG. 4) can include any suitable input devices and/or sensors that can be used to receive user input, such as a keyboard, a mouse, a touchscreen, a microphone, and so on.

In some embodiments, communications systems 408 (FIG. 4) can include any suitable hardware, firmware, and/or software for communicating information over communication network 354 (FIG. 3) and/or any other suitable communication networks. For example, communications systems 408 can include one or more transceivers, one or more communication chips and/or chip sets, and so on. In a more particular example, communications systems 408 (FIG. 4) can include hardware, firmware, and/or software that can be used to establish a Wi-Fi connection, a Bluetooth connection, a cellular connection, an Ethernet connection, and so on.

In some embodiments, memory 410 (FIG. 4) can include any suitable storage device or devices that can be used to store instructions, values, data, or the like, that can be used, for example, by processor 402 (FIG. 4) to present content using display 404 (FIG. 4), to communicate with server 352 (FIG. 3) via communications system(s) 408 (FIG. 4), and so on. Memory 410 (FIG. 4) can include any suitable volatile memory, non-volatile memory, storage, or any suitable combination thereof. For example, memory 410 (FIG. 4) can include random-access memory (RAM), read-only memory (ROM), electrically programmable ROM (EPROM), electrically erasable ROM (EEPROM), other forms of volatile memory, other forms of non-volatile memory, one or more forms of semi-volatile memory, one or more flash drives, one or more hard disks, one or more solid state drives, one or more optical drives, and so on. In some embodiments, memory 410 (FIG. 4) can have encoded thereon, or otherwise stored therein, a computer program for controlling operation of computing device 350 (FIG. 3). In such embodiments, processor 402 (FIG. 4) can execute at least a portion of the computer program to present content (e.g., images, user interfaces, graphics, tables), receive content from server 352 (FIG. 3), transmit information to server 352 (FIG. 3), and so on. For example, the processor 402 (FIG. 4) and the memory 410 (FIG. 4) can be configured to perform the methods described herein (e.g., the method of FIG. 1, the method of FIG. 2).

In some embodiments, server 352 (FIG. 3) can include a processor 412 (FIG. 4), a display 414 (FIG. 4), one or more inputs 416 (FIG. 4), one or more communications systems 418 (FIG. 4), and/or memory 420 (FIG. 4). In some embodiments, processor 412 (FIG. 4) can be any suitable hardware processor or combination of processors, such as a CPU, a GPU, and so on. In some embodiments, display 414 (FIG. 4) can include any suitable display devices, such as an LCD screen, LED display, OLED display, electrophoretic display, a computer monitor, a touchscreen, a television, and so on. In some embodiments, inputs 416 (FIG. 4) can include any suitable input devices and/or sensors that can be used to receive user input, such as a keyboard, a mouse, a touchscreen, a microphone, and so on.

In some embodiments, communications systems 418 (FIG. 4) can include any suitable hardware, firmware, and/or software for communicating information over communication network 354 (FIG. 3) and/or any other suitable communication networks. For example, communications systems 418 can include one or more transceivers, one or more communication chips and/or chip sets, and so on. In a more particular example, communications systems 418 (FIG. 4) can include hardware, firmware, and/or software that can be used to establish a Wi-Fi connection, a Bluetooth connection, a cellular connection, an Ethernet connection, and so on.

In some embodiments, memory 420 (FIG. 4) can include any suitable storage device or devices that can be used to store instructions, values, data, or the like, that can be used, for example, by processor 412 (FIG. 4) to present content using display 414 (FIG. 4), to communicate with one or more computing devices 350 (FIG. 3), and so on. Memory 420 (FIG. 4) can include any suitable volatile memory, non-volatile memory, storage, or any suitable combination thereof. For example, memory 420 (FIG. 4) can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 420 (FIG. 4) can have encoded thereon a server program for controlling operation of server 352 (FIG. 3). In such embodiments, processor 412 (FIG. 4) can execute at least a portion of the server program to transmit information and/or content (e.g., data, images, a user interface) to one or more computing devices 350 (FIG. 3), receive information and/or content from one or more computing devices 350 (FIG. 3), receive instructions from one or more devices (e.g., a personal computer, a laptop computer, a tablet computer, a smartphone), and so on.

In some embodiments, the server 352 (FIG. 3) is configured to perform the methods described in the present disclosure. For example, the processor 412 (FIG. 4) and memory 420 (FIG. 4) can be configured to perform the methods described herein (e.g., the method of FIG. 1, the method of FIG. 2).

In some embodiments, data source 302 (FIG. 3) can include a processor 422 (FIG. 4), one or more data acquisition systems 424 (FIG. 4), one or more communications systems 426 (FIG. 4), and/or memory 428 (FIG. 4). In some embodiments, processor 422 (FIG. 4) can be any suitable hardware processor or combination of processors, such as a CPU, a GPU, and so on. In some embodiments, the one or more data acquisition systems 424 (FIG. 4) are generally configured to acquire data, images, or both. Additionally or alternatively, in some embodiments, the one or more data acquisition systems 424 (FIG. 4) can include any suitable hardware, firmware, and/or software for capturing images of beehives, such as a still photograph or video camera.

Note that, although not shown, data source 302 (FIG. 3) can include any suitable inputs and/or outputs. For example, data source 302 (FIG. 3) can include input devices and/or sensors that can be used to receive user input, such as a keyboard, a mouse, a touchscreen, a microphone, a trackpad, a trackball, and so on. As another example, data source 302 (FIG. 3) can include any suitable display devices, such as an LCD screen, an LED display, an OLED display, an electrophoretic display, a computer monitor, a touchscreen, a television, etc., one or more speakers, and so on.

In some embodiments, communications systems 426 (FIG. 4) can include any suitable hardware, firmware, and/or software for communicating information to computing device 350 (FIG. 3) (and, in some embodiments, over communication network 354 (FIG. 3) and/or any other suitable communication networks). For example, communications systems 426 (FIG. 4) can include one or more transceivers, one or more communication chips and/or chip sets, and so on. In a more particular example, communications systems 426 (FIG. 4) can include hardware, firmware, and/or software that can be used to establish a wired connection using any suitable port and/or communication standard (e.g., VGA, DVI video, USB, RS-232, etc.), Wi-Fi connection, a Bluetooth connection, a cellular connection, an Ethernet connection, and so on.

In some embodiments, memory 428 (FIG. 4) can include any suitable storage device or devices that can be used to store instructions, values, data, or the like, that can be used, for example, by processor 422 (FIG. 4) to control the one or more data acquisition systems 424 (FIG. 4), and/or receive data from the one or more data acquisition systems 424 (FIG. 4); to generate images from data; present content (e.g., data, images, a user interface) using a display; communicate with one or more computing devices 350 (FIG. 3); and so on. Memory 428 (FIG. 4) can include any suitable volatile memory, non-volatile memory, storage, or any suitable combination thereof. For example, memory 428 (FIG. 4) can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 428 (FIG. 4) can have encoded thereon, or otherwise stored therein, a program for controlling operation of data source 302 (FIG. 3). In such embodiments, processor 422 (FIG. 4) can execute at least a portion of the program to generate images, transmit information and/or content (e.g., data, images, a user interface) to one or more computing devices 350 (FIG. 3), receive information and/or content from one or more computing devices 350 (FIG. 3), receive instructions from one or more devices (e.g., a personal computer, a laptop computer, a tablet computer, a smartphone, etc.), and so on.

In some embodiments, any suitable computer-readable media can be used for storing instructions for performing the functions and/or processes described herein. For example, in some embodiments, computer-readable media can be transitory or non-transitory. For example, non-transitory computer-readable media can include media such as magnetic media (e.g., hard disks, floppy disks), optical media (e.g., compact discs, digital video discs, Blu-ray discs), semiconductor media (e.g., RAM, flash memory, EPROM, EEPROM), any suitable media that is not fleeting or devoid of any semblance of permanence during transmission, and/or any suitable tangible media. As another example, transitory computer-readable media can include signals on networks, in wires, conductors, optical fibers, circuits, or any suitable media that is fleeting and devoid of any semblance of permanence during transmission, and/or any suitable intangible media.

As used herein in the context of computer implementation, unless otherwise specified or limited, the terms “component,” “system,” “module,” “framework,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

What is claimed is:

1. A computer-implemented method of detecting bee population health comprising:
receiving an image of a beehive;
partitioning the image into a plurality of sub-images;
applying a trained model to the plurality of sub-images to generate a plurality of bee density maps corresponding to the plurality of sub-images; and
generating a bee population estimate from the plurality of bee density maps.

2. The method of claim 1, wherein the trained model comprises a convolutional neural network-based scale-adaptive regression network and a plurality of convolution layers and a plurality of dilated convolutions.

3. The method of claim 1, further comprising:
obtaining a training image of bees;
annotating the training image by associating each bee with a pixel coordinate; and
generating a training density map comprising normalized distributions associated with the bee pixel coordinates.

4. The method of claim 3, wherein the training density map comprises a two-dimensional array comprising a total number of array elements corresponding to a total number of pixels in the training image and wherein each of the normalized distributions is centered at an array element corresponding to one of the bee pixel coordinates.

5. The method of claim 1, further comprising:
partitioning the training image into a plurality of training sub-images; and
generating the training density map as one of a plurality of training density maps, each training density map corresponding to one of the plurality of training sub-images.

6. The method of claim 1, further comprising generating, based on the bee population estimate, an ecosystem health indicator of an ecosystem comprising the beehive.

7. The method of claim 6, wherein the ecosystem health indicator comprises a contaminant indicator, an air quality indicator, a water quality indicator, a plant health indicator, a habitat loss indicator, a climate change indicator, a pathogen contamination indicator, a heavy metal contamination indicator, a chemical contamination indicator, or a radiation contamination indicator.

8. A system for detecting bee population health, comprising:
a processor;
a non-transitory computer-readable medium storing instructions executable by the processor to:
receive an image of a beehive;
partition the image into a plurality of sub-images;
apply a trained model to the plurality of sub-images to generate a plurality of bee density maps corresponding to the plurality of sub-images; and
generate a bee population estimate from the plurality of bee density maps.

9. The system of claim 8, wherein the trained model comprises a convolutional neural network-based scale-adaptive regression network and a plurality of convolution layers and a plurality of dilated convolutions.

10. The system of claim 8, wherein the stored instructions are further executable by the processor to:
obtain a training image of bees;
annotate the training image by associating each bee with a pixel coordinate; and
generate a training density map comprising normalized distributions associated with the bee pixel coordinates.

11. The system of claim 10, wherein the training density map comprises a two-dimensional array comprising a total number of array elements corresponding to a total number of pixels in the training image and wherein each of the normalized distributions is centered at an array element corresponding to one of the bee pixel coordinates.

12. The system of claim 8, wherein the stored instructions are further executable by the processor to:
partition the training image into a plurality of training sub-images; and
generate the training density maps as one of the plurality of training density maps, each training density map corresponding to one of the plurality of training sub-images.

13. The system of claim 8, wherein the stored instructions are further executable by the processor to generate, based on the bee population estimate, an ecosystem health indicator of an ecosystem comprising the beehive.

14. The system of claim 13, wherein the ecosystem health indicator comprises a contaminant indicator, an air quality indicator, a water quality indicator, a plant health indicator, a habitat loss indicator, a climate change indicator, a pathogen contamination indicator, a chemical contamination indicator, a heavy metal contamination indicator, or a radiation contamination indicator.

15. A non-transitory computer-readable medium storing instructions for detecting bee population health and executable by a processor to:
receive an image of a beehive;
partition the image into a plurality of sub-images;
apply a trained model to the plurality of sub-images to generate a plurality of bee density maps corresponding to the plurality of sub-images; and
generate a bee population estimate from the plurality of bee density maps.

16. The non-transitory computer-readable medium of claim 15, wherein the trained model comprises a convolutional neural network-based scale-adaptive regression network and a plurality of convolution layers and a plurality of dilated convolutions.

17. The non-transitory computer-readable medium of claim 15, wherein the stored instructions are further executable by the processor to:
obtain a training image of bees;
annotate the training image by associating each bee with a pixel coordinate; and
generate a training density map comprising normalized distributions associated with the bee pixel coordinates.

18. The non-transitory computer-readable medium of claim 17, wherein the training density map comprises a two-dimensional array comprising a total number of array elements corresponding to a total number of pixels in the training image and wherein each of the normalized distributions is centered at an array element corresponding to one of the bee pixel coordinates.

19. The non-transitory computer-readable medium of claim 15, wherein the stored instructions are further executable by the processor to generate, based on the bee population estimate, an ecosystem health indicator of an ecosystem comprising the beehive.

20. The non-transitory computer-readable medium of claim 19, wherein the ecosystem health indicator comprises a contaminant indicator, an air quality indicator, a water quality indicator, a plant health indicator, a habitat loss indicator, a climate change indicator, a pathogen contamination indicator, a chemical contamination indicator, a heavy metal contamination indicator, or a radiation contamination indicator.
